(19) United States
(12) Patent Application Publication
(10) Pub. No.: US 2017/0093247 A1
(43) Pub. Date: Mar. 30, 2017

(54) ENERGY STORAGE DEVICE AND ENERGY STORAGE SYSTEM

(71) Applicant: Christian Spinner, Berlin (DE)

(72) Inventor: Christian Spinner, Berlin (DE)

(21) Appl. No.: 15/315,467

(22) PCT Filed: Jun. 1, 2015
(86) PCT No.: PCT/EP2015/062161

§ 371 Date: Dec. 1, 2016

(30) Foreign Application Priority Data
Jun. 4, 2014 (DE) 20 2014 004 799.5

(51) Int. Cl. H02K 7/02; H02K 7/18; F03G 3/08

(52) U.S. Cl. CPC H02K 7/025; F03G 3/08; H02K 7/1807

(57) ABSTRACT

An energy storage device has a horizontal flywheel (1). The flywheel (1) has a mass ring made of concrete (3) and is at least partially embedded in the soil (4).

### BACKGROUND

1. Field of the Invention

The present invention relates to an energy storage device, consisting of a very large, specifically inexpensive flywheel and a technical overall concept that allows for a high system efficiency level as well as a highly flexible energy storage system.

2. Description of the Related Art

It is known that flywheels are capable of storing energy. Since the invention of the flywheel, efforts have been made to store more and more energy within a defined economic framework as well as to improve the system's efficiency level. The meaning of system hereinafter also includes the manner in which the flywheel is supplied with energy, the way it is stored and then withdrawn again, in addition to the use of the flywheel as a storage medium.

In general, the energy stored in a flywheel depends primarily on three factors: the mass and the radius of the rotating medium as well as its rotational speed. The efficiency level is dependent on the ability to reduce or minimize friction and active power losses in the system. The costs depend on the selected materials, the system's design and the efficient interaction of components throughout the flywheel system.

Today's development attempts to achieve high rotational speeds in excess of 50,000 rpm/min by the use of new materials or to reduce the friction losses to nearly zero. The fact that only relatively little energy can be stored in the flywheel is something that all flywheel accumulators have in common.

Particularly in this day and age when increasingly more electric power is generated from renewable sources, the synchronization of the electricity supply and demand for electricity is becoming increasingly important. Especially increasing capacities of less predictable wind and solar power generation increase the need to provide flexibility (buffer) in the power system so that the regional power supply and demand do not have to be synchronous for a certain time. There are currently two answers to that: new electricity supply lines to transport excessive or lacking electricity from or to the power system, respectively, and electricity storage. New electricity supply lines often fail because of a lack of acceptance on part of the population, and energy storage devices are still relatively small and expensive.

Therefore the present invention's purpose is to provide an advantageous energy storage device which can be produced in a particularly simple and inexpensive manner. Another purpose of said invention is to provide an advantageous energy storage system.

### SUMMARY

An inventive energy storage device has a horizontal flywheel, comprising a mass ring made of concrete, and which is at least partially embedded in the soil. The concrete of the flywheel may be filled around a structure of reinforced steel in order to increase the strength of the flywheel. In addition, the mass ring may include a steel shell into which the concrete is filled. The steel shell increases the stability of the flywheel's rim and may also serve as a casting shell when casting the flywheel. The steel shell may be divided into a number of compartments into each of which the concrete (3) is filled. In terms of manufacturing technology this has the advantage that only small volumes need to be filled with concrete.

An energy storage system with an inventive energy storage device is a storage device for large amounts of energy with high efficiency levels. It can be put to use flexibly and locally and moreover it can be built relatively easily and economically. Thus it offsets the drawbacks of today's popular energy storage systems, such as pumped-storage electrical plants, compressed air reservoirs, batteries or the earlier flywheels. But also the more expensive and unpopular construction of lines can thus largely be avoided.

In a first embodiment of the inventive energy storage device the mass ring is mounted on an air bearing and/or plain bearing and/or steel wheels. The steel wheels may run in rails arranged at the bottom of the steel shell. Moreover motors for driving the flywheel and/or generators for decelerating the flywheel may be arranged on the steel wheels.

This bearing has multiple benefits. For the main part it is to bear the load of the storage medium so that it may rotate at the lowest possible friction resistance. On the other hand, the bearing is meant to be used for driving and decelerating the mass ring. This is achieved by the steel wheels bearing parts of the load, on one hand, but which may be driven by motors and decelerated by generators, on the other hand, in order to store or withdraw energy. The number of air bearings/plain bearings and steel wheels is dependent on the size and the mass of the storage ring as well as on the technical advantageousness and they should ideally be evenly distributed below the storage medium.

In a second embodiment of the inventive energy storage device the mass ring itself serves as the rotor of a motor/generator. In this case, the stator surrounds the mass ring in the form of a ring.

In the inventive energy storage device the mass ring may have air bearings and/or plain bearings or steel wheels on its peripheral surface. The air bearings and/or plain bearings or steel wheels on the peripheral surface may provide vertical stability of the mass ring. In addition, the air bearings and/or plain bearings or steel wheels may also include sensors to ensure the smooth running of the flywheel.

In an advantageous development of the inventive energy storage device the mass ring has a widening at its bottom. This provides more space for the bearing of the motors and the generators as well as a larger storage volume at the same rate of rotation. The widening may start at the mass ring, extending in the radially outward direction and/or the radially inward direction. If the widening starts at the mass ring, extending in the radially inward direction, it may be such that it closes the bottom of the mass ring.

In order to store a lot of energy the mass ring has an outer radius, for example, of at least 10 m, preferably at least 30 m and more preferably at least 50 m and/or a height of at least 5 m, preferably at least 10 m and more preferably at least 20 m.

In order to achieve a positive effect on the security and stability of the energy storage device, the mass ring may be fully embedded in the soil. In case of a defect of the energy store device the soil may protect the environment, for example, from debris.

An inventive energy storage system comprises at least one regenerative energy source and one inventive energy storage device.

Further features, properties and advantages of the invention will become apparent from the following description of exemplary embodiments with reference to the accompanying figures.

### BRIEF DESCRIPTION OF THE DRAWINGS

FIG. 1 shows an example for an inventive energy storage device comprising a horizontal flywheel.

FIG. 2 shows the arrangement of rails, wheels and bearings at the bottom of the flywheel of FIG. 1.

FIG. 3 shows an example of a first alternative form of the flywheel of FIG. 1.

FIG. 4 shows an example of a second alternative form of the flywheel of FIG. 1.

FIG. 5 shows a first example of an alternative bearing of the flywheel of FIG. 1.

FIG. 6 shows a second example of an alternative bearing of the flywheel of FIG. 1.

FIG. 7 shows an alternative input and output design of the flywheel of FIG. 1.

### DETAILED DESCRIPTION

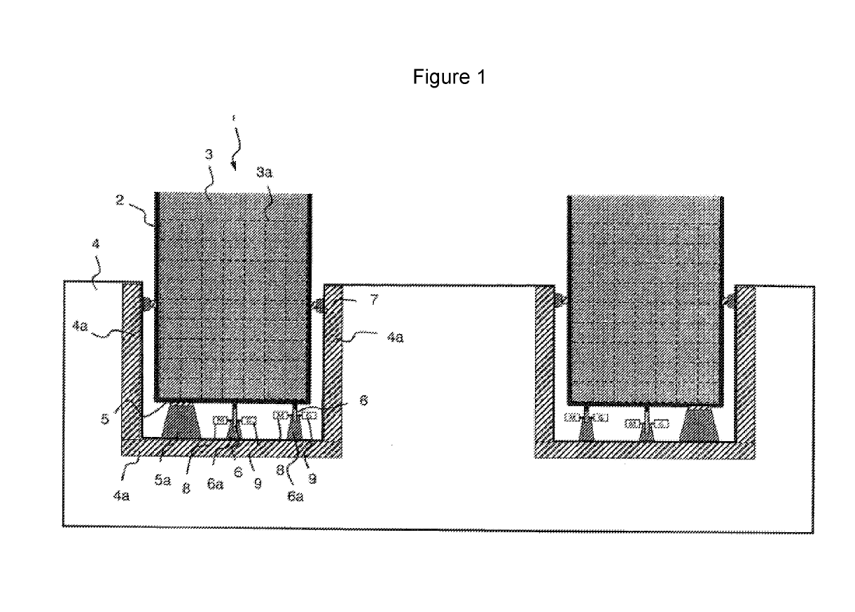

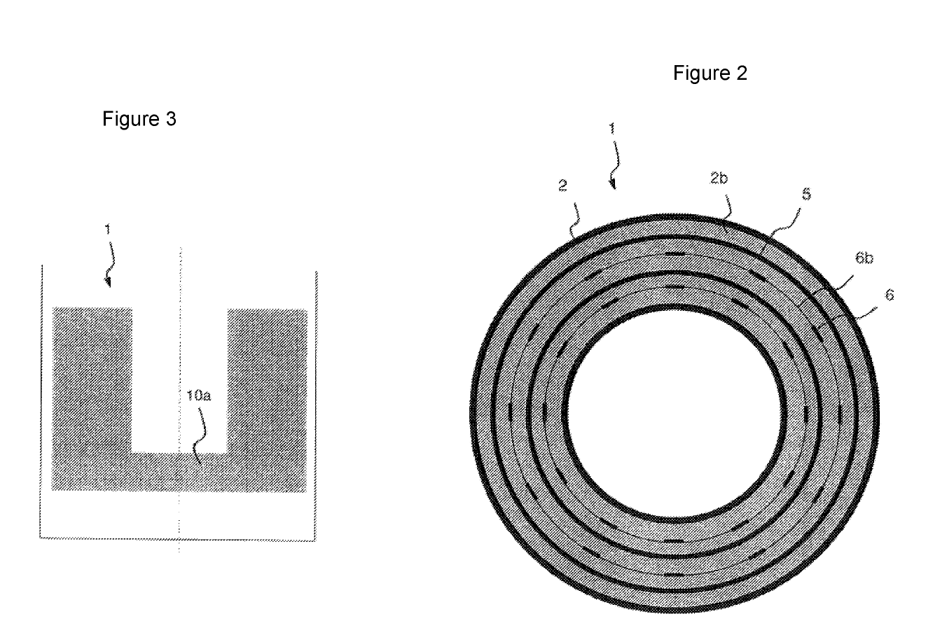

A first embodiment of the present invention will be described below with reference to FIGS. 1 and 2.

The inventions comprises a system capable of storing a relatively large amount of energy (in some cases up to several GWhel) at relatively high efficiency levels (in some cases more than 90%) over a relatively long period of time (in some cases several hours or days).

The essence of the invention is a large horizontal flywheel 1, as outlined in FIG. 1 in longitudinal section. The flywheel is arranged horizontally in order to avoid vibrations which usually occur with vertical flywheels. Moreover, it is ideally embedded in the soil 4 in order to have a positive effect on the security and stability, and it rests on a foundation 4a. In the context of the invention the flywheel 1 is used as a storage ring for storing energy.

The shaping component is a steel shell ring 2 whose wall thickness depends on the respective size of the flywheel 1. It is meant for stability, in particular with large radial velocities. The steel shell is filled with concrete 3, the primary mass-forming material. In order to withstand the tensile force resulting during rotation, the concrete 3 is filled around a reinforced steel structure 3a. The materials mentioned for clarity may also be replaced by other materials. Instead of using a steel shell ring it is also possible to use one or a plurality of steel bands or steel belts.

The mass ring has multiple and various bearings, including air bearings and/or plain bearings 5 and steel wheels 6 that are mounted on stable foundations 5a, 6a. Motors 8 and/or generators 9 are attached to the steel rims 6. For vertical stability stabilizers 7 are provided, which may be either air bearings and/or plain bearings or steel wheels. They should also contain sensors that are needed to ensure smooth running.

The bearing has multiple benefits. It is primarily meant to bear the load of the storage medium, i.e. the flywheel 1, so that it can rotate at the lowest possible friction resistance. On the other hand, the bearing is also to be used to drive and decelerate the flywheel 1. This is achieved by the steel wheels 6 bearing parts of the load, one one hand, but which may be driven by the motors 8 and decelerated by the generators 9, on the other hand, in order to store or withdraw energy. The steel wheels 6 run on suitable rails 6b which are mounted at the bottom 2b of the steel shell 2 (see FIG. 2). The number of air bearings/plain bearings 5 and steel wheels 6 are dependent on the size and mass as well as on the technical advantageousness of the flywheel 1 and should ideally be evenly distributed below the flywheel 1.

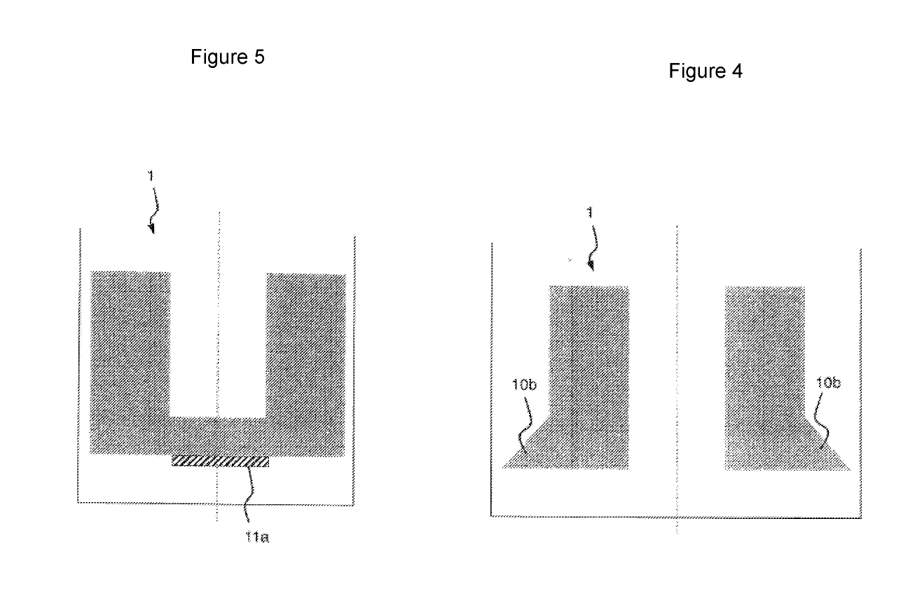

Alternative forms of the storage ring are shown in FIGS. 3 and 4. In the illustrated forms the flywheel 1 has a widening 10a, 10b at its bottom in radial direction. This provides more space for the bearing of the motors and generators. In the form shown in FIG. 3, the flywheel 1 has a widening 10 a at its bottom which is extending in the radially inward direction. In this case the widening may be such that it closes the bottom of the flywheel 1, as is the case with the flywheel illustrated in FIG. 3. However, the widening 10b may also start at the flywheel 1 in the radially outward direction instead of the radially inward direction, as is shown in FIG. 4.

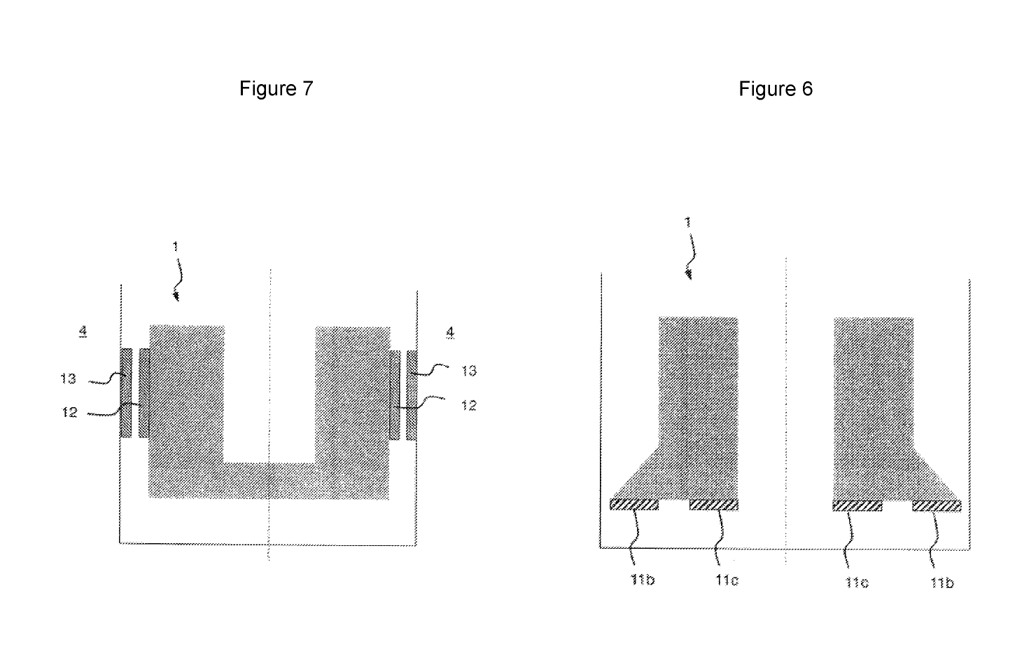

The flywheels illustrated in FIGS. 3 and 4 may also have alternative bearings compared to the flywheel shown in FIG. 1. These are exemplified by plain bearings 11a, 11b, 11c in FIGS. 5 and 6.

An alternative input and output design is illustrated in FIG. 7. In this design the entire flywheel 1 does not only serve as a storage ring but also as a rotor of the motor and the generator. FIG. 7 is a schematic representation of the rotor winding 12 at the flywheel 1 and the stator winding 13 which is located in the area of the surrounding soil 4. Since the entire storage ring serves as a rotor of the motor and the generator in this embodiment, the bearing on steel wheels may be superfluous and may therefore be omitted.

Unlike conventional flywheels the inventive flywheel is characterized by a vast size, a high mass and inexpensive material. The rotating body of the inventive flywheel may have the following characteristics:
The appearance is a ring
It has a relatively large inner and outer diameter (e.g. >50 m)
The height of the ring depends on the desired mass (e.g. >20 m)
The mass-forming material is reinforced concrete or a similar solid and heavy matter
The reinforced concrete ring is incorporated with a U-shaped steel shell

A flywheel with a diameter of 50 m, a ring thickness of 25 m and a height of 30 meters weighs approximately 440,000 tons. With a rotational speed of 40 rpm/min this flywheel is able to store a kinetic energy of about 1 GWh of current equivalent (equivalent to an annual electricity consumption of more than 250 households in Germany).

One challenge is the bearing of the rotating medium. The objective is to have a mix of various bearings. However, steel wheels 6 on which the flywheel 1 rests are of importance. Their axes have motors 8 and generators 9 which accelerate or decelerate the flywheel 1 in order to store or withdraw energy.

The dimension of the storage medium is such that different components (motors 8, generators 9) can be used simultaneously. Thus alternate current and direct current components may be used simultaneously, or components that are connected to different voltage levels, fulfilling the market's and/or the individual customers' requirements. Different input and output requirements may be operated on the same storage medium. This makes the storage system efficient, effective and scalable.

The high system efficiency level is achieved within the system by additional energy sources which are to be built specifically for this purpose, which in particular may be renewable energy sources mitigating any losses of the efficiency level, in the best case, fully compensating them. The electric power generated from renewable sources drives motors which are supposed to keep the flywheel 1 on the rotation speed reached after the energy storage. Ideally/At the most a system efficiency level of 100% may thus be achieved. With the additional energy source, friction losses of the rotating flywheel 1 can be compensated and its rate of rotation can be kept constant. It is important to mention that the energy sources, e.g. renewable sources, are specifically built for increasing the efficiency level of the storage system; thus “additionality” is given.

The invention brings the flywheel 1 to the stage of power storage technologies to be seriously considered, with attractive applications. Thus the inventive storage device, for example, is able to draw excess 50 Hz alternate current and solar direct current and redeliver it as 16.7 Hz traction current. The same applies also vice versa if, for example, the railway system employs systems for energy retrieval on a larger scale.

The inventive energy storage, in particular the rotating storage medium, deliberately abstains from hightech. Materials are used which have been ready for the market and merchantable for some time.

Nevertheless, or precisely for this reason, there are active power losses in said energy storage device which in some cases could be above those of the flywheels that rely on expensive high technologies. These losses are to be mitigated in the storage system, in the best case, even fully compensated: specifically generated energy, in particular renewable energy, is adding additional drive to the flywheel in order to compensate for the system's efficiency losses. As a representative example of these energy sources wind power plants or photovoltaic power plants should be mentioned. Depending on the market maturity and the costs, Sterling engines, ORC systems (Organic Rankine Cycle) or TEGs (thermoelectric generators) may be used, utilizing the waste heat of the storage system to generate electricity.

The particular type of the design and the bearings of the storage medium offers the opportunity to build a multi-functional energy storage device of high flexibility. Where today different energy storage devices are required in order to be able to offer necessary electricity products, only one power storage device is required in case of the inventive energy storage device. In particular this is due to the bearing of the storage medium on steel wheels that has been described, to the axes of which different motors and generators may be attached which can be precisely and efficiently matched to the demands of the market:
Precise match in terms of considering today's and future electricity products. Motors and generators may be incorporated specifically for the various needs. To illustrate this point further, here a conceivable real world example: an inventive energy storage device is located at a triple interface of the traction current grid, the public current grid and the current grid of a large industrial client which requires high capacity peaks in form of direct current several times a day. The industrial client is now able to purchase (excess) electricity (at a favorable price) throughout the day from the two other channels and fill up the energy storage device with the aid of suitable motors. If the client now needs a capacity peak he takes it directly from the energy storage device with his direct current generator, thus avoiding high costs for holding capacities in the public power grid.
Efficient in terms of an optimal allocation of capacities. If, for example, an energy storage device which is to be charged and discharged with an electric capacity of up to 100 MW is provided, then an optimal allocation of motors and generators may be made. In order to illustrate this further, here an example: Assume that the highest efficiency level with the best price-efficiency-ratio will be achieved by means of a 5 MW motor. Then 20 of these motors will be incorporated into the system. If the storage device is now to store three hours of 60 MW electricity, 12 motors are working at their most efficient point for three hours. The same applies to the withdrawal of energy for the generators.

The specific design of the rotating storage medium and its bearing allow for the use of the inventive energy storage device as a valuable piece of the puzzle in the turnaround of the energy policy in Germany or in energy systems elsewhere in the world. Electricity will become storable on a grand scale, thus making energy management somewhat easier.

### LIST OF REFERENCE NUMBERS

1 Flywheel
2 Steel shell
2b Bottom
3 Concrete
3a Reinforced steel
4 Soil
4a Foundation
5 Plain bearing 5a Foundation
6 Steel wheel 6a Foundation
7 Stabilizer
8 Motor
9 Generator
10a Widening
10b Widening
11a Plain bearing
11b Plain bearing
11c Plain bearing
12 Rotor winding
13 Stator winding

1. An energy storage device with a horizontally arranged flywheel (1), wherein the flywheel (1) comprises a mass ring made of concrete (3) and which is at least partially embedded in the soil (4).

2. The energy storage device of claim 1, wherein the mass ring comprises a steel shell (2) into which the concrete (3) has been filled.

3. The energy storage device of claim 2, wherein the steel shell is divided into a number of compartments into which the concrete (3) has been filled respectively.

4. The energy storage device of claim 1, wherein the concrete (3) has been filled around a reinforced steel structure (3b).

5. The energy storage device of claim 2, wherein the mass ring is mounted on an air bearing and/or plain bearing (5) and/or steel wheels (6).

6. The energy storage device of claim 5, wherein the steel wheels (6) are running on rails (6b) which are arranged at the bottom (2b) of the steel shell (2).

7. The energy storage device of claim 5, further comprising motors (8) for driving the flywheel (1) and/or generators (9) for decelerating the flywheel (1), the motors (8) and/or the generators (9) being arranged at the steel wheels (6).

8. The energy storage device of claim 1, wherein the mass ring serves as a rotor of a motor/generator and the stator surrounds the mass ring in the form of a ring.

9. The energy storage device of claim 1, wherein the mass ring has stabilizers (7) on its peripheral surface.

10. The energy storage device of claim 9, wherein the stabilizers are air bearings and/or plain bearings (7) or steel wheels.

11. The energy storage device of claim 1, wherein the mass ring has a widening (10a, 10b) at its bottom.

12. The energy storage device of claim 11, wherein the widening (10b) starts at the mass ring, and extends in the radially outward direction.

13. The energy storage device of claim 11, wherein the widening (10a) starts at the mass ring, extending in the radially inward direction.

14. The energy storage device of claim 13, wherein the widening (10a) closes the bottom of the mass ring.

15. The energy storage device of claim 1, wherein the mass ring has an outer radius of at least 10 m and/or a height of at least 5 m.

16. The energy storage device of claim 15, wherein the mass ring has an outer radius of at least 30 m and/or a height of at least 20 m.

17. The energy storage device of claim 1, wherein the mass ring is fully embedded in the soil (4).

18. An energy storage system comprising at least one energy source and the energy storage device of claim 1.

19. The energy storage system of claim 18, wherein the energy source is a regenerative energy source.
